(19) United States
(12) Patent Application Publication
(10) Pub. No.: US 2005/0153020 A1
(43) Pub. Date: Jul. 14, 2005

(54) Composition comprising phosphate

(76) Inventors: Per Hamre, Sandnessjoen (NO); Andreas Skulberg, Oslo (NO); Finn Relestad, Barum (NO)

Correspondence Address: CHRISTIAN D. ABEL, ONSAGERS AS, POSTBOKS 6963 ST. OLAVS PLASS, NORWAY, N-0130, NO

(21) Appl. No.: 10/507,838

(22) PCT Filed: Mar. 19, 2003
(86) PCT No.: PCT/NO03/00094

(30) Foreign Application Priority Data
Mar. 19, 2002 (NO) 20021369
Oct. 9, 2002 (NO) 200224880

(51) Int. Cl. A23K 1/175

(52) U.S. Cl. 426/74

(57) ABSTRACT

The present invention concerns a composition comprising phosphate wherein phosphate, as the main active ingredient, corrects mammalian phosphate depletion and the use thereof. The composition may be in form of a powder, an infusion solution or a sports drink. Inlet of the sports drink or administration of the infusion solution to an athlete or an animal, or to a patient who suffers from a condition needing extra supply of phosphate is advantageous for the treatment or the prevention of a variety of conditions.

The present invention is related to a composition comprising phosphate as the active ingredient, and which is made in such a way that it can be given to an athlete or an animal, or to a patient suffering from a condition demanding extra supply of phosphate. The present invention also relates to the use of the composition for the manufacture of an infusion solution or a drink for the treatment or the prevention of a variety of conditions.

The mammalian organism makes use of physical and chemical mechanisms to functions fast and targeted in such a way that the organism may exploit its possibilities adequately. An example of this is transport and uptake of glucose. The intestinal transport of glucose is slow, but as the blood flow along the intestines is fast, it suffices with simple physical uptake of glucose in the blood. Glucose is transported to the liver and stored there as glycogen. It can be mobilized quickly as glucose when needed. Another example is the lungs and their function. Oxygen diffuses from the alveoli to the lung circulation, and immediately after diffusion the oxygen is bound to hemoglobin. In this way the concentration gradient between alveoli and blood is maintained, and the diffusion continues until hemoglobin no longer can bind more oxygen (i.e. the blood is saturated).

Monosaccarides diffuse selectively from the bloodstream to the extracellular space (the interstitium) and from there to the cells. This occurs through a secondary active transport where monosaccharides are linked to a carrier protein, and transported into a cell together with phosphate and sodium. Phosphate is essential for the degradation of monosaccharide in the cells, and by degradation phosphate is liberated and free to leave the cell.

Adenosine triphosphate (ATP) constitutes high-energy phosphate in the cells. When ATP is converted to adenosine diphosphate (ADP), energy and phosphate are liberated. ADP may furthermore be transformed to adenosine monophosphate (AMP). In this step energy is liberated as well, but the energy is much less than by converting ATP to ADP. AMP may be degraded further to adenosine and uric acid and by this phosphate is lost.

Glucose is a very important substance for the body as it is an important source of energy for many tissues, especially brain tissue. If the glucose level decreases, as during strenuous exercise, one can observe various symptoms. This entails that athletes performing great muscular work often eat glucose to ameliorate their performances.

Utilization of glucose in the body is a process depending on phosphate. However, the prior art have not considered that a sufficient phosphate supply is of any importance. One reason for this may be that the body contains so much phosphate that supply of phosphate has been regarded as not problematic. Another reason may be that there up to now generally has been focused on oxygen in the blood, as it is well known that oxygen has to be present for aerobe metabolism of glucose to take place. Anaerobic turnover may take place, but this will produce lactic acid and threaten important cell functions. Usually such an acidosis will lead to reduced cell function, or even arrest in cell functions. For a muscle cell this means stop in the demand for energy, but after a while the muscle cell is again ready to function. Measurements of phosphate levels in the blood will then show normal values.

By resuscitation the situation is different. Rehncrona et al. (1) showed in 1980 that rats which were exposed to inhibited cerebral circulation for 30 minutes developed an excessive cellular acidosis after restoring normal circulation in the brain. Rats on normal diet had higher levels of lactic acid than those who had been fasting. Later is has been shown by Welsh et al. (2) that infusion of glucose in cats before cerebral ischemia results in greater brain damage than what has been found in animals without glucose supply. Warner et al. (3) found that hyperglycemic rats after provoked cerebral ischemic insult had worse survival figures than normoglycemic rats. The explanation for this is that the brain cells need aerobic energy for their restitution. If brain cells do not have access to such energy they may be inflicted with permanent damage in contrast to muscle cells which may attain full function after rest.

Oxygen is required in the cell for aerobic metabolism to take place. The blood level of oxygen is important as well, but oxygen also has to diffuse from the capillaries into the extracellular space. Oxygen must therefore be liberated from the red blood cells. For this to happen, 2,3-diphosphoglycerate (2,3-DPG) has to be present. This represents a substance containing phosphate. If 2,3-DPG is lacking, the oxygen dissociation curve is <<shifted>> to the left. This means that less oxygen is liberated from the red blood cells and little oxygen is available for the body cells, even if the blood may be saturated with oxygen.

It is known that long lasting <<steady-state>> training intervals reduce the amount of 2,3-DPG in athletes performing endurance sports. Reduced level of phosphate give reduced amount of 2,3-DPG. It is also shown that intense training or competition gives adaptive response by increasing oxygen demand such that the amount of 2,3-DPG is increased to augment oxygen delivery to the cells. The effect of various training/competition levels will reflect 2,3-DPG-level. By increased demand for oxygen the production of 2,3-DPG is increased. By reduced phosphate in the blood this response is lacking.

Glucose is one of the most used nutritional factors given intravenously and is often used in the clinic without expecting any danger. However, by large amounts of glucose in the blood, or by large transport of glucose, hypophosphatemia may develop (HP) since glucose transport is dependent upon phosphate. The phosphate serum level in adults is between 0,8 and 1,5 mmol/l. Values below 0,8 give symptoms of HP. The symptoms appear when levels approach 0,3 mmol/l, consisting inter alia of weakness, confusion, and in severe cases, cramps and coma.

Betro and Pain (4) showed in 1972 that in 40% of 100 hospitalized patients (53 men and 27 women) with HP, defined as <2 mg/100 ml serum, the HP was caused by glucose infusion. This was the most frequent cause of HP. The second most important cause was emesis (12%). In 6 of the cases the patients had myocardial infarction without cardiac failure. The incidence of HP was found to be 0,9% in a material of 1001 non-hospitalized patients. The cause of HP is that glucose infusion makes phosphate follow glucose into the cell. Another possibility for reduction of phosphate in the blood is injection of adrenalin. The authors mention that potassium deficit may cause damage to the renal tubuli, with resulting leakage of phosphor. Studies have also shown that supplying glucose may worsen cerebral ischemic damage in cats (2), and in hyperglycemic rats cramps and brain edema were shown even after short-lasting ischemia (3). Young et al (5) described in 1982 a patient with craniocerebral damage wherein metabolic factors lead to that the patient was wrongly diagnosed as brain dead. The serum phosphate level of this patient was of 0,9 mg/dl. Lee et al. (6) described in 1978 three cases of serious HP, all comatose, where one patient died and two survived. The survivors became better after intravenous infusion of phosphate. The phosphate level of the patient who died was low when admitted to hospital. He was then well awake but dehydrated, and was administered 0,9% NaCl intravenously, alternating with 5% glucose. Over the next 24 hours the patient became confused and went into coma, with a serum phosphate level of 0,3 mg/dl. The patient was diagnosed as suffering from pancreatitis. During the next 48 hours metabolic acidosis was diagnosed, and he was treated with 5% glucose, 0,9% NaCl and NaHCO₃. The patient remained comatose and died 72 hours after being admitted. Phosphate was never given.

Sudden administration of carbohydrates may give marked HP. Hypophosphatemia seems to be initiated by transfer of phosphate from the extracellular to the intracellular space. This is linked to the role of phosphate in transporting oxygen and glucose. Franks et al. (7) reported in 1948 HP when treating diabetic acidosis. Insulin therapy may give a decline of phosphate level in the blood, and increased elimination in urine. Death may occur after the acidosis is regulated, normal blood sugar level established, and adequate amounts of water and NaCl is administered. This indicates lack of other elements, maybe phosphate and potassium.

When resuscitating, it is well known that glucose infusion makes the prognosis worse. It is also shown that alcoholics, in cases where their phosphate levels were low, could become unconscious after glucose infusion (5%). Further, it is shown by Tanaka et al. in 1985 (8) that cats given glucose before being inflicted with cerebral ischemia had a worse prognosis than cats which were not given glucose. Energy production and the extent of glycolysis is not dependant on glucose supply. Glucose consumption may be inhibited by intrinsic factors like expressed acidosis. Dale et al. showed in 1986 (9) marked HP, defined as less than 0,32 mmol/l (1 mg/100 ml), in endurance runners who became confused and incapable of taking care of themselves. The symptoms disappeared after rest and at the same time phosphate values became more normal. If glucose is given in such situations, the situation is deteriorating, which is shown both experimentally and in practice. Furthermore, it is shown that all types of serious shock give a rapid depletion of the cellular reserves of phosphate and concurrently the new influx of phosphate is very low (only 2% per hour). Thus supply of phosphate is important in serious shock conditions (10).

The speed of the energy uptake is among factors affecting the organism's utilization of drinks meant for restoring loss of glucose, liquid and electrolytes. This speed will depend upon emptying of the stomach and transport from the intestinal lumen into the blood. These represent important functions which do not seem to be sufficiently emphasized in the prior art. Emptying of the stomach is known to be affected by the following:
1. Increased volume of the gastric content results in improved and faster emptying.
2. High content of energy reduces the speed of emptying. This is related to very high energy content.
3. The speed of emptying is an inverse function of the osmolality of the gastric content.
4. Physical work intensity higher than about 75% of maximal oxygen uptake results in reduced emptying.
5. The speed of emptying increases with pH oh the gastric content.
6. Dehydration before heavy muscular work inhibits gastric emptying and increase the possibility of feeling of distress.

It is therefore an important characteristic that a sports drink, which effectively shall supply the body with energy and salts over a short time, must be emptied quickly from the stomach and not gives the user any feeling of sickness nor distress. Transport from the intestinal lumen into the blood is dependent upon the nutritional substances. It is known in the art that energy should not be supplied as fructose since this can result in abdominal pain and nausea. The transport of fructose from the intestine is slow and different from the known active glucose transport, which occurs simultaneously with absorption of sodium and results in facilitated water transport. Transport of fructose will however not result in increased water transport and this is unfortunate in a situation wherein supply of energy, salts and liquids must occur quickly.

The osmolality of the nutritional solution seems however not to affect the rate of transport across the intestinal wall since it is known that hypotonic solutions of carbohydrates/electrolytes are not transported more quickly from the intestinal lumen than isotonic or very hypertonic solutions.

There exist many patents related to so-called <<sports drinks>>, aiming at replacing inter alia loss of glucose, fluid and salts as a result of physical activity. Examples of such patents are U.S. Pat. No. 6,296,892, U.S. Pat. No. 6,039,987, U.S. Pat. No. 5,117,723, U.S. Pat. No. 9,749,304, U.S. Pat. No. 4,309,417, U.S. Pat. No. 5,032,411 and U.S. Pat. No. 5,114,723, as well as several patents referred to in the above cited publications. In these sports drinks phosphate is generally added in small amounts, often as a by-product (for instance in the form of potassium phosphate where the intention is to add potassium) or a non-specific electrolyte, and where the intention of the supply is different from the present invention. Furthermore in EP B1 40654 it is provided a composition for restoring the electrolyte deficit in a subject. Phosphate is added only for maintenance of a pH level between 6.8 and 7.4. Energy is added in form of sucrose and dextrose. CN A 1233423, ZA 6906214, ZA 8709292 describe sports drinks comprising electrolytes and energy (dextrose, glucose sugar) for restoring body fluids, salts trace elements etc. Phosphate is not mentioned as an active principle. ZA 8709292 is especially indicated as hypotonic. GB A 2180451 comprises peroxide phosphate compound which counteract endotoxins. The solution is claimed to inhibit hypotensive shock and localized bone reabsorption caused by endotoxins.

EP 0040654 discloses a drink concentrate comprising disodium hydrogen phosphate. The main object of this drink concentrate is the supply of electrolytes. Further, the drink concentrate disclosed in EP 0040654 also comprise sucrose. Sucrose is a disaccharide consisting of fructose and glucose. Thus, the drink disclosed in EP 0040654 differs from the sports drink according to the present invention as it includes fructose. In addition, the drink disclosed in said patent comprises much smaller amounts of phosphate compared to the present invention.

EP B1 508488 comprises the use of inositol triphosphate (IP₃) to produce a medicament for the treatment and prevention of various inflammatory conditions. IP₃ is an intracellular second messenger which mediates a wide variety of physiological functions, including related to the biosynthesis of prostaglandins. Thus, the mechanism of action of IP3 is most likely not related to the supply of phosphate.

WO 01/13900 Comprises methods to treat cardiovascular conditions by administering pyridoxal-5′-phosphate and other pyridoxal salts. WO 01/06873 comprises a composition to treat muscular exhaustion and related conditions, wherein the active ingredients are a combination of L-carnithine and/or at least one alkanoyl L-carnithine and creatinol phosphate. The effect of these methods are most likely not due to the supply of phosphate.

None of the above compositions are directed to phosphate as the active principle to restore phosphate deficit, even though compositions containing phosphate are known. Also, the amount of phosphate in the compositions disclosed in the prior art are relatively low.

There are also other patents where various forms of phosphate are included in various contexts for mixtures to treat among other myocardial infarction and shock. Examples of such patents are U.S. Pat. No. 5,039,665, EP 508 488, EP 28 336, WO 2001 13900, GB 2 180 451 and WO 2001 06873. However, neither none of these patents describe the use of phosphate as the primary active ingredient, but rather as part of organic molecules where phosphate may not even be a necessity. On the contrary, the person skilled in the art would expect that the mechanism of action of creatinol-O-phosphate was not simply related to the supply of phosphate since it is stated that the creatinol-O-phosphate causes a positive ionotropic effect. Further, U.S. Pat. No. 5,039,665 relates to the use of fructose-1-phosphate and thus differs from the present invention in that the supply of fructose is avoided since in fact fructose provoke nausea.

As evidenced from the present description, phosphate is required for adequate transport in the body of both glucose and oxygen. Consequently, it is important that the amount of phosphate available is large enough such that the transport in situations of huge energy demand/>>crisis situations>> may be optimal. The last is seen in situations of great work load, as in competition with great physical work, or for instance when there is heavy energy demand on brain cells. Shortage of phosphate in these instances may impact on the brain cells and lead to death of the individual. Currently, there is no existing solution aiming at supplying an individual with specific needs for phosphate to ensure that important cellular processes may function optimally.

It is thus the intention with the present invention to provide a solution containing phosphate, designed in such a way that it may be given to an athlete, to an animal, or to a patient suffering from a condition requiring additional supply of phosphate. This intention is obtained by the present invention, characterized by the enclosed claims.

### SUMMARY OF THE INVENTION

The present invention concerns a solution comprising phosphate as primary ingredient, where the intention is to supply the solution to a person or an animal in need thereof, to secure optimal transport of glucose and oxygen to various types of tissue in situations where they are exposed to heavy work loads. Thus, the phosphate is the active principle in the compositions of the present invention and is not added as a buffer to maintain a specific pH level of the solution. The drink according to the present invention inter alia reduces the formation of lactic acid and increases aerobic capacity.

In relation to one embodiment of the present invention, the composition comprises about 1-17 g phosphate (1 mmol-180 mmol) and wherein phosphate, as the main active ingredient, corrects mammalian phosphate depletion.

Further, the composition according to the present invention facilitates the emptying of the stomach and the transport of the active ingredient, energy, electrolytes and water from the intestine into the blood stream.

In one embodiment, the composition is a powder which is dissolved in a suitable liquid such as e.g. potable or distilled water immediately prior to the use of the composition.

Preferably, the composition comprises 1-8 g phosphate (10 mmol-85 mmol) per 1, more preferably 4 g phosphate (42,5 mmol) per liter. The composition according to the present invention may preferably be in the form of a sports drink, and with the provision that the composition does not comprise fructose. The composition may in addition preferably comprise preservative, stabilizer (such as sodium benzoate and potassium sorbate), buffer, flavoring agents and optionally sugar (except fructose).

In one preferred embodiment, the composition according to the present invention is a sports drink comprising;
1-17 g phosphate/I,
20-80 g monosaccharides (except fructose) and/or maltodextrines per liter (2-8%),
trisodiumphosphate (for sodium supply and pH adjustment) added to pH 3-5 (taste dependant),
0,01-5 g malic acid and/or other flavoring agents per liter,
0,01-025 g per liter of stabilizer E 211, sodium benzoate

In another embodiment, the present composition is a drink suitable for animal use comprising:
1-17 g phosphate/l,
trisodiumphosphate (for sodium supply and pH adjustment) added to pH 3,5-5 (taste dependant),
60 g melasse 60 per liter,
0,01-0,25 g/l of stabilizer E 211, sodium benzoate.

In still another embodiment, the present composition is a drink suitable for a horse.

In yet another embodiment, the present composition is in the form of a solution for infusion and wherein the composition is isotonic, and preferably having the following composition;
1-17 g phosphate/l,
trisodiumphosphate up to isotonic solution and pH >4.

The present invention also provides a composition that it in addition to the previous described ingredients may comprise acetylsalicylic acid. In one preferred embodiment, the present composition comprises
1-17 g phosphate/l,
1-1000 mg acetylsalicylic acid/l
trisodiumphosphate up to isotonic solution and pH >4.

In still another embodiment, a solution is made by dissolving said dry powder, a tablet or a concentrate in water, wherein the concentrations of phosphate, glucose and optionally melasse are in accordance the present invention.

Further, the present invention provides the use of a composition according to invention for the manufacture of a solution prepared such that it may be administered to e.g. a subject, such as an athlete or an animal, or to a patient suffering of a condition needing extra supply of phosphate. In one embodiment, the subject suffers from the repercussion of the inlet of ethyl alcohol and wherein the composition preferably is administered immediately prior to the inlet of ethyl alcohol, immediately after the inlet of ethyl alcohol, before bedtime, ant the next morning, before nutrition consumption.

Further, according to the use of the present invention the composition may be administered to a person suffering from or in risk of receiving osteoporosis, and wherein the composition is optionally is administered together with calcium.

Also, in one embodiment the use of phosphate according to the present invention for the manufacturing of a preparation is suitable for the treatment of a patient being resuscitated or who has hypoxic injuries as a consequence of for instance cardiac arrest, infarction (for example myocardial infarction or stroke), shock and diabetic acidosis, or by the following, but not limited to; heart surgery, long lasting emesis, extended burns, large injections of insulin, poorly controlled diabetes, sepsis, malnutrition and other complications of alcoholism, traumas, adrenalin injections, parenteral hyperalimentation, alcohol withdrawal, severe metabolic or respiratory alkalosis, nasogastric suction, malabsorption, primary hyperthyroidism, acute severe asthma, acute respiratory failure and intravenous carbohydrate supply. The composition provides and/or enhances the formation of 2,3-DPG in an subject in need thereof, preferably in such a way that a sufficient supply of oxygen to the brain is provided.

Finally, in still another embodiment the present invention relates to a kit comprising the powder composition according to the invention, liquid and further ingredients such as e.g. stabilizer, buffers, flavoring agents and optionally sugar (except fructose), in a manner which allows production of the solution immediately before use.

In still another embodiment, the present invention provides a kit comprising the powder composition according to the invention, buffers, and optionally acetylsalicylic acid, in addition to adequate equipment for managing intravenous administration of the solution, in a manner which allows production of the solution immediately before use.

### DETAILED DESCRIPTION OF THE INVENTION

The present invention will now be described in more detail, with references to figures and examples. It is to be appreciated that the different embodiments disclosed below are meant to be illustrative only and are not to be construed to limit the scope of the disclosed invention and the enclosed claims.

### BRIEF DESCRIPTION OF THE FIGURES

FIG. 1 shows a capillary (1), the intercellular space (2) and a cell (3) wherein transport of glucose (wide arrow) and oxygen (thin arrow) from the capillary into a cell is indicated.

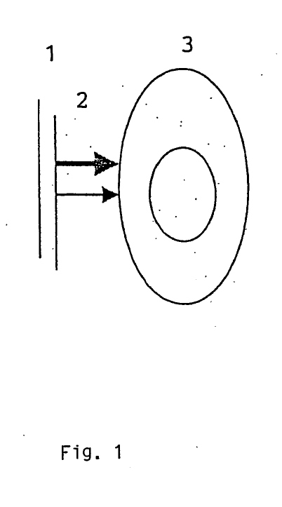

FIG. 2 shows glucose metabolism (glycolysis).

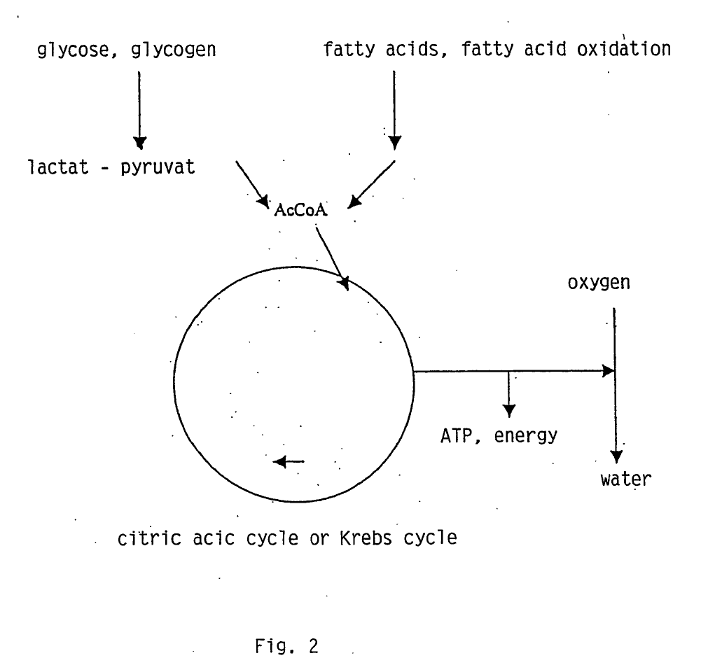

The aim of the present invention is to supply phosphate in a solution to e.g. an athlete or an animal (competing animals, preferably horse), or to a patient being resuscitated or who has hypoxic injuries following inter alia cardiac arrest, infarct (for instance myocardial infarction or stroke), shock or diabetic acidosis. Furthermore, a composition according to the present invention may be used in connection with the following conditions, but are not limited to these; heart surgery, long lasting emesis, large burns, huge supply of insulin, poorly controlled diabetes, sepsis, deficient nutritional supply and other alcoholic complications, traumas, adrenalin injections and carbohydrate supply. It is the opinion of the inventors that the need for phosphate, in these cases and according to traditional thinking, is grossly underestimated. Established thinking in sports physiology and in emergency medicine is that phosphate is always available because the body contains much of this substance. Phosphate is, however, not easily mobilized when required in large amounts, a point that has been overlooked up until now.

Phosphate has many important physiological functions. Regarding sports medicine, the following properties are important:

Phosphate is essential for the production of 2,3 DPG and thus for liberating O₂ from the erythrocytes. By reduced availability of phosphate the liberation of O₂ is diminished.

Phosphate is important for transport of sugar form blood to the cells.

Phosphate plays an important role in the cells by enzymatic degradation of sugar, whereby ATP is formed.

By short-lasting extreme work loads and by submaximal long-lasting competition and training phosphate is consumed and bound in such a way that available phosphate is decreasing as the phosphate depots are being rapidly depleted. The result is decreased aerobic capacity and increased production of lactate.

Supply of phosphate before physical exercise secures optimal phosphate amount before start. Supply of phosphate during exercise secures adequate phosphate levels such that the aerobic capacity is maintained and lactic acid production is decreased. Supply of phosphate after physical exercise reduces the chance for accumulation of lactic acid and over-training, and gives better restitution after training.

86% of the body phosphate is stored in the bone system, 14% is in the cells and only 0,3% in the extracellular space. This is a small amount that is easily drained under extraordinary loads. Normal serum phosphate levels in blood samples in fasting persons are 0.9 to 1.5 mmol/l. Young persons have higher levels. In plasma, 70% exists as phospholipids and 30% as inorganic phosphate (mono- and dihydrogen-phosphate) functioning as a depot and pH buffer. The kidneys play an important role in phosphate homeostasis. By giving large doses of phosphate to persons with high plasma levels of phosphate, the kidneys will effectively get rid of the surplus. If the plasma level is reduced, the kidneys will block further excretion of phosphate by reabsorption in the tubular system (12-13). Phosphate intake to persons with healthy kidneys is safe in the amounts considered here. It is important to have a high level of hemoglobin for athletic performance, but according to the inventors it is also important with phosphate supply beyond the normal (0.8 g/day). It is also important to have large depots of glycogen during physical exercise, but supply of glucose under such conditions may be dangerous if the phosphate level is low.

Phosphate is, as already mentioned, a ubiquitous substance to be found everywhere in the body, and in relatively large amounts for a mineral. It is required in many metabolic processes, inter alia for aerobic consumption of glucose in the cells and for transport of glucose from the blood into the cells. If oxygen is not available for the muscle cells during work, lactic acid is produced and the milieu becomes acid. This reduces the capacity for muscle work considerably. Heavy muscle work furthermore demands supply of energy inn the form of glucose, and phosphate is required for the metabolism of glucose. Such phosphate is not always available. By supplying phosphate, both aerobic consumption of glucose and adequate transport of oxygen into the cells are secured. A drink/sports drink according to the present invention will secure an adequate supply of phosphate in heavy physical work, and thus increase physical capacity and reduce the formation of lactic acid in an athlete or an animal exposed to heavy physical work.

By excessive training lactic acid accumulates in the musculature. This may easily lead to non-optimal patterns of movement leading to injuries in joints, tendons and ligaments. These are structures with scarce blood supply, and injuries here have a tendency to heal slowly, or become chronic. Phosphate supply may reduce the impact of excessive training, and sequelae to this. Improved healing may be accomplished by facilitating aerobic metabolism.

In relation to one embodiment the present invention provides therefore a composition, preferably a drink/sports drink containing phosphate, and which composition facilitates quick uptake in the body in that the energy is added as glucose, the solution is weakly hypertonic and the pH is from 3-5. The drink according to the present invention reduces the formation of lactic acid and increases aerobic capacity (Example 3). Supplement of the drink/sports drink increases aerobic capacity in an athlete or a competing animal in a simple and perfectly legal way. The effect of excessive training may be alleviated, and both athletes and animals may tolerate larger exercise doses. The composition according to the present invention is thus applicable before, during and after heavy physical exercise. It is especially recommended to drink during warm up to secure a liquid volume in the stomach without creating abdominal discomfort. This will facilitate gastric emptying since it is known that gastric emptying is reduced when the stomach is empty (see above) even though liquid is supplied. Furthermore it is important that the drink according to the present invention also is taken during muscular exercise. The drink contains furthermore adequate energy content which is lower than the volume which reduce the rate of gastric emptying. The slight hypertonicity of the drink is in addition to weak to reduce the rate of gastric emptying.

In a preferred embodiment glucose is selected as energy source, in concentrations between 2 and 8% (weight/volume), preferably 6% (weight/volume). Since glucose is connected to sodium in the small intestine and then quickly is transported into the blood, together with a following passive transport of water, the drink has a relative large content of sodium. In addition to adequate transport of energy, phosphate and electrolytes the composition according to the invention secures thereby that the transport of water from the small intestine to the blood is optimal. This represents an important feature since adequate water transport is decisive during long lasting muscular work.

A concentration of glucose of e.g. 6% (weight/volume) means that if the athlete shall be able to maintain adequate supplement of carbohydrates (30-60 g/hour) he/she must drink about 750 ml/hour of the present drink. Since the stomach cannot receive more than 900-1000 ml/hour, the present drink will be able to supply an adequate amount of energy given the volume of liquid the stomach is able to tolerate per hour.

It is a considerable problem that sports drinks are acid, with much sugar, and that they are being consumed frequently in small amounts, creating favorable conditions for dental caries. The drink/sports drink according to the present invention therefore has a pH of 3-5, preferable 3-4, more preferable 3,3. This composition represents a dental protecting sports-drink. In one embodiment of the drink the pH is 3.3, a value which in addition to dental protection will stimulate gastric emptying related to a known commercially available sports drink with pH=2, since it is known that a small increment of the pH results in a large increase of the rate of gastric emptying.

The composition of the present invention is suitable for the production of solutions/drinks which can be used by athletes, individuals exercising for fitness and to relieve symptoms related to intake of alcohol.

If oxygen is not available in adequate amounts in the brain cells during critical conditions, lactic acid is formed and the milieu becomes acid. The prognosis for surviving resuscitation, or limiting effects of hypoxic injuries, is radically reduced. In such instances there is a great need for large amounts of phosphate both for transport of oxygen and glucose to the cells, and to aerobic metabolism. Giving glucose to patients being resuscitated is malpractice because it creates acidosis and worsening of the prognosis for survival. It is contraindicated to give glucose before it is shown that glucose level is low. This is seemingly paradoxical, as the brain craves for energy. It is the opinion of the inventors that such acidosis is due to lack of phosphate. By supplying a patient in such a situation with an infusion of phosphate in accordance with the present invention, the patient will have an increased chance of survival as a result of increasing aerobic metabolism and combating acidosis. During this treatment there may be a need for supplying glucose if hypoglycemia is confirmed. Control of phosphate must be monitored during treatment.

After myocardial infarct the oxygen tension in the heart muscle drops to zero in a matter of seconds and the heart shifts to anaerobic metabolism. This leads to that the unstable form of high energy phosphate (ATP) and the energy storage of phosphate (creatine phosphate) is weakened in a matter of minutes. Lactic acid is accumulating and pH is lowered, inhibiting the glycolytic enzyme phosphofructokinase and thus slowing the glycolytic pathway. This leads to weakening of the heart function in the ischemic area in a matter of seconds. It is the opinion of the inventors that to give phosphate in the acute phase of myocardial infarct may limit the necrosis developing in the heart muscle and thus limit the size of the infarction.

The infusion solution according to the present invention may contribute to increased chances for survival by resuscitation, and reduce the damage rising from resuscitation, infarct (for example myocardial infarct or stroke), shock or diabetic acidosis. It may also be used in heart surgery, long lasting emesis, extensive burns, large insulin injections, poorly controlled diabetes, sepsis, malnutrition and other complications in alcoholism, traumas, adrenalin injections and intravenous carbohydrate supply. The isotonic solution containing phosphate may be formed by dissolving a powder, a tablet or a concentrate in water, and which may be used on the same indications as mentioned for the infusion solution.

So-called <<non-steroidal anti-inflammatory drugs>> such as e.g. acetyl salicylic acid is well known used against coagulation, both as a prophylactic and as first aid in myocardial infarct. Today this has to be ingested in tablet form, which may be problematic. The present infusion solution may therefore in addition to phosphate and buffers also comprise acetylsalicylic acid. The infusion solution according to the present invention thus contributes to the reduction of damages by resuscitation, infarction (for example myocardial infarction or stroke), shock and diabetic acidosis. It may be used in cases where there is a need for prophylaxis against coagulation or the formation of thrombi. The isotonic solution which contains phosphate is a solution made by dissolving a powder, a tablet or a concentrate in water, and which may be used on the same indications as mentioned for the infusion solution.

The infusion solution may be administered intravenously by the use of suitable equipment and methods well known to the person skilled in the art. Equipment for intravenous administration may include, but are not limited to, tubes, syringes, needles etc.

The following examples will further clarify the invention without limiting the scope of the enclosed claims.

### EXAMPLES

### Example 1

### Surgery with the Use of Anesthesia

This example shows dire consequences of too low content of phosphate in the body.

Some years ago general anesthesia was used for a minor elective surgery in a hospital. A week before a blood sample was taken from the patient wherein everything was normal except from a phosphate value of 0.67 mmol/l. This small reduction was considered to be insignificant. Introduction of anesthesia was without problems and the nurse responsible for anesthesia controlled pulse and blood pressure every 10 minutes. After approximately 30 minutes, surgery was started, and neither pulse nor blood pressure could be detected. The anesthesiologist was summoned, and resuscitation was started. There was ventricular fibrillation, and defibrillation was successful. About an hour later the patient was transferred to a university hospital in the same city. At arrival the patient was ventilated, but there was sign of own respiration, and it was attempted to let the patient breathe herself. Reaction of the pupil was normal, and pain perception was evident. The prognosis was considered uncertain, but not hopeless. The patient was moved to an emergency ward, but some hours later the condition worsened and all reflexes disappeared. Once again blood samples were taken for blood gas analysis, and this time electrolytes were measured. The serum phosphate was 0.04 mmol/l, a value everybody considered to be wrong, and a new arterial blood sample was taken. This time the value was 0.05 mmol/l. Next day it was evident that the patient had no more cerebral circulation and further treatment was abandoned.

### Example 2

### Test on Boxers

A bag test (consisting of the trainer holding the punch bag as the boxer hits the bag and number of punches thrown and the strength of the punches are registered) was performed on 5 boxers. The bag test lasted 4 rounds of 2 minutes with maximal physical effort and 20 seconds pause between the rounds. The blood lactate levels showed marked increase each round, with approximately a linear slope. All the boxers started with pulse in the range of 160-170 beats/min and arrived at a maximum pulse of about 190-200 beats/min. The number of punches and the force of the punches were registered. The boxers only drank water during warm-up and in the pauses.

The same bag test was repeated 3 weeks later. The boxers now drank 1 liter sports drink according to the present invention; a hypotonic solution with 4 g phosphate 1-2 hours before the test. During warm-up and in the pauses between the rounds they drank small quantities of the same composition. The lactic acid level curve flattened a bit earlier than in the first test. The boxers reached maximal pulse earlier, and could perform more and faster. The number of hits on the bag and the power of each punch were both increased.

### Example 3

### Test on Two Elite Boxers

A sports drink according to the present invention was given to two elite boxers who participated in an international boxing event. They were given 1 liter of the sports drink containing 4.5 g of phosphate the day before the fight, and at the day of the fight.

Both boxers achieved results far beyond expectation. One, an inexperienced 20 years old Norwegian with 34 fights on his record, lost by two points to a much merited Egyptian boxer. The Norwegian, however, won the last round and became markedly better, relatively speaking, in the last rounds. The other became quite unexpected Norwegian junior champion after fighting a 3 year older and much more experienced favorite in the class. Halfway into the fight he was 10 points below, but turned the fight around in the last two rounds and won. He was voted <<best boxer in the event>> and qualified for the Nordic championship for juniors. Both boxers stated that they hardly experienced fatigue, and at the same time the expected muscular stiffness (lactic acid accumulation) was not present.

### Example 4

### Study of Soccer Players

An inquiry was performed on 24 soccer players in the Norwegian National League who in a period of 3 months used 2 recognized and well known commercially available sports drinks. All reported side effects such as nausea, and gastrointestinal distress which in 35-40% of the participants caused so much discomfort that the stopped using the drink. When the same subjects used the sports drink according to the present invention for the same period of time no side effects were reported.

### Example 5

### Effect on Distress Following Alcoholic Intoxication

Five subjects (4 males and 1 female), age 30-35 years, were given the drink according to the present invention to study its effect on after-effects related to consumption of ethyl alcohol.

All had during the evening a mixed intake of beer, wine and liquor in amounts which produced a blood concentration of alcohol between 1 and 1.5 per thousand. This amount and mixture gave usually each subject distress symptoms such as headache, nausea, optionally emesis the morning after.

Each subject carried through a regime comprising intake of 500 ml of the composition according to the present invention in the hours before the start of the alcohol intake, 500 ml-1000 ml after the alcohol intake, before going to sleep and 500 ml the next morning, before possible intake of breakfast.

As a result no one reported any discomfort at all after an alcohol intake which normally resulted in considerable discomfort.

### Example 6

### Use of Extra Phosphate Supply During Training After Cardiovascular Illness

A 69 years old male had previously suffered from cardiac infarct. After recovery he started a training program comprising 5 km walking 4 times a week. After a period, in which he developed a cold and disrupted the training, he noticed a considerably poorer fitness when the exercise was resumed characterized by more short windedness after 5 km than previously. After intake of the composition according to the present invention he reported that he could cover the same distance with faster steps and higher speed without experiencing short windedness. According to his opinion this was an effect of the drink since no other parameters were changed.

### Example 7

### Cross Over Study the Effect of the Sports Drink According to the Present Invention in Biathlon Athletes

The Norwegian national team of biathlon athletes (males and females) used the sports drink according to the present invention in approximately 1 week before a World Cup competition. The results in the cross country part of the competition were astonishingly good, actually on the same level as the results of the national cross country team.

The team then switched to a conventional, commercially available sports drink for about 3 weeks, after which they took part in a new World Cup competition. The results this time were considerably poorer. During this competition they switched back to the sports drink according to the present invention and already the day after they performed better, and 2 days after the results were back on the same level as after using the present drink for 1 week.

### Example 8

### Composition of a Sports Drink

A sports-drink according to the present invention may have the following composition:

| | 1 liter contains | |
|---|---|---|
| In solution, phosphate | 1-17 | g |
| Na | 700-1200 | mg (30-54 mmol) |
| Mg | 50 | mg (2 mmol) |
| In addition | 20-80 | g |
| Monosaccarides (with the exception of | | |
| fructose) maltodextrines 2-8% | | |
| Malic acid (or other flavoring agents like, | 0.01-5 | g |
| but not limited to orange, lemon, black | | |
| currant, peaches etc.) | | |
| Other electrolytes | | |
| K | 180 | mg (4.6 mmol) |
| Ca | 200 | mg (5 mmol) |
| E 211, sodium benzoat and/or | 0.01-0.25 | g pref. 0.15 |
| E 203, potassium sorbate as preservative | 0.01-0.5 | pref. 0.25 |
| and stabilizer | | |

Tri-sodium phosphate, Na₃PO₄ (for supply of sodium and pH adjustment) added to pH 3-5, preferably pH 3.3 to protect the teeth. Water is added to 1 liter of drink.

According to another embodiment the sports drink may comprise the following:
4 g phosphate where some of the phosphate may be potassium phosphate
60 g monosaccharides (with the exception of fructose)
trisodiumphosphate (for supply of sodium and pH adjustment) added to pH 3-5 (taste dependant), pH above 3 is desirable to protect the teeth, preferably pH 3-4, more preferably pH 3.3
1 g malic acid (or other flavoring agents like, but not limited to orange, lemon, black currant, peaches etc.)
stabilizer (E 211, sodium benzoate, 0,0625 g; E 203 potassium sorbate, 0.9 g)
water is added to 1 liter of drink.

The above mentioned composition is preferably manufactured as dry powder to be dissolved in water before use, or as a soluble tablet. The composition may also be produced as a concentrate to be added to water before being used.

Phosphate is preferably added in the form of NaH₂PO₄2H₂O, containing about 600 g phosphate/kg. Other sources of phosphate include, but are not limited to, potassium phosphate, calcium phosphate and magnesium phosphate, preferably potassium phosphate, or mixtures of one or more phosphates, both inorganic and organic.

In a bottle of 750 ml 3 g phosphate is preferably added (equivalent to 5 g NaH₂PO₄2H₂O). For <<loading>> of the body before hard and long lasting exercise 750 ml of the sports drink may be taken 1-2 hours before start to optimize the phosphate content and for distension of the ventricle for better emptying. In hard exercise of duration of 45-60 minutes, 250 ml of the sports drink may be given every 15-20 minutes. By short lasting exercise where much lactic acid is produced, there may be a <<loading>> of the body 2-3 days before start including the day of competition. For example, 1 liter of sports drink the day(s) before start and 1 liter on the day of competition, where the last 500 ml is given maximum 2 hours before/during warm-up.

### Example 9

### Composition of a Drink

An embodiment of a drink suitable for an animal, preferably a horse, and according to the present invention may have the following composition:
1 g to 17 g phosphate,
trisodium phosphate (for sodium supply and pH adjustment) added to pH 3
5 (taste dependant); pH around 4 is sought,
0.01 g 100 g melasse,
stabilizer (E 211, sodium benzoate, 0.01-0.25 g),
water added to 1 liter drink

Another embodiment of the drink designed for animals may comprise;
4 g phosphate
trisodium phosphate (for sodium supply and pH adjustment) added to pH 3-4 (taste dependant); pH around 4 is desired,
60 g melasse
stabilizer (E 211, sodium benzoat, 0,0625 g),
water is added to 1 liter drink

The above mentioned compositions are preferably manufactured as dry powder to be dissolved in water before use, or as a soluble tablet. The composition may also be produced as a concentrate to be dissolved in water before being used.

### Example 10

### Composition of a Solution for Infusion

The solution has to be isotonic which implies 280 mmol/l of salts. 1 g sodium dihydrogenphosphate gives 5.6 mmol/l phosphate and 11.2 mmol/l Na (according to the pharmacopoeia Martindale (11)). One liter isotonic solution only containing sodium dihydrogenphosphate contains 16.7 g.

A solution for infusion according to the present invention will contain between 1 and 17 g sodium dihydrogenphosphate per liter, preferably 1-8 g, more preferably 4 g/l, or another phosphate compound, specially potassium phosphate, or mixture of various phosphate compounds, both inorganic and organic, to produce the desired amount of phosphate. Of other phosphate compounds, potassium phosphate is important. To the solution is added from 0 g and upwards of buffer, for example trisodium phosphate, to obtain an isotonic solution of pH >4. The solution may be with or without acetylsalicylic acid. An intravenous solution according to the present invention may have the following compositions:

1 liter solution without acetylsalicylic acid may contain:
4 g phosphate, preferably sodium dihydrogenphosphate
trisodiumphosphate to isotonic solution
pyrogen free and sterile water to 1 liter

1 liter solution without acetylsalicylic acid may contain:
4 g phosphate, preferably sodium dihydrogenphosphate and potassium phosphate
trisodium phosphate to isotonic solution
pyrogen free and sterile water to 1 liter

1 liter solution without acetylsalicylic acid may contain:
4 g phosphate of various phosphates
trisodiumphosphate to isotonic solution
pyrogen free and sterile water to 1 liter

1 liter solution with acetylsalicylic acid may contain:
4 g phosphate(s)
1-1000 mg acetylsalicylic acid
trisodiumphosphate to isotonic solution
pyrogen free and sterile water to 1 liter

### Example 11

### Test of the Sports Drink

The test of the sports drink according to the invention is performed on 24 subjects. The study is a double blind study wherein each subject is his own control, and drinks a known commercially available sports drink, a placebo drink and a sports drink according to the present invention respectively. The placebo drink comprises water and flavoring agents such that all drinks have exactly the same taste. The drink according to the present invention corresponds to the composition described in Example 8 and comprises inter alia 4 g/l phosphate and 60 g/l glucose.

The test battery comprises measuring the energy metabolism at submaximal exercise loads and measurement of the anaerobic threshold (AT)/lactate profile, measuring the maximal oxygen uptake (VO₂ max) and a performance test, in addition to measuring the lactate elimination. All exercise tests are performed on a exercise bicycle.

Each subject drinks 1 l of the drink every day during three days and thereafter the test battery is run.

### Example 12

### Effect of Phosphate on Resuscitation

The study is performed on desert rats with PET scanning (positron emission scanning).

The animals, fed and watered ad lib, are separated in two groups. Cerebral anoxia is performed in both groups by reversibly clamping the cerebral circulation. After normal cerebral circulation is restored one group is infused with Ringer solution and the second group is infused with an infusion solution according to the present invention, with phosphate as active principle. In both group glucose and oxygen supply to the brain is measured by PET scanning.

### REFERENCES

1 Rehncrona S, Rosen I, Siesjø B K. Excessive cellular acidosis: An important mechanism of neuronal damage in the brain. Acta Physiol Scand 1980; 110: 435-7.
2 Welsh F A, Ginsberg M D, Rieder W, Budd W W. Deleterious effect of glucose pretreatment on recovery from diffuse cerebral ischemia in the cat. Stroke 1980; 11 (4): 355-63.
3. Warner D S, Smith M L, Siesjø B K. Ischemia in normo- and hyperglycemic rats: Effects on brain water content and electrolytes. Stroke 1987; 18: 464-71.
4. Betro M G, Pain R W. Hypophosphatemia and hyperphosphatemia in a hospital population. Br Med J 1972; I: 273-6.5. Young G B, Amacher A L, Paulseth J E, Gilbert J J, Sibbald W J. Hypophosphatemia versus brain death. Lancet 1982; i: 617.
5. Young G B, Amacher A L, Paulseth J E, Gilbert J J, Sibbald W J. Hypophosphatemia versus brain death. Lancet 1982; i: 617.
6. Lee J L, Sibbald W J, Holliday R L, Linton A L. Hypophosphatemia associated with coma. Can Med Assoc J 1978; 119: 143-5.
7. Franks M, Berris R F, Kaplan N P. Metabolic studies in diabetic acidosis —II. Arch Intern Med 1948; 81: 42-55.
8. Tanaka K, Welsh F A, Greenberg J H, O'Flynn R et al. Regional alterations in glucose consumption and metabolite levels during postischemic recovery in cat brain. J Cereb Blood Flow Metabol 1985; 5: 502-11.
9. Dale G, Fleetwood J A, Sainsbury J R C. Profound hyposphosphatemia in patients collapsing after a <<fun run>>. Br Med J 1986; 292: 447-8.
10. Guyton A C, Hall J E Circulatory Shock and Physiology of its Treatment, in Guyton A C, ed. Textbook of Medical Physiology 9^{th} ed. Philadelphia Pa.: W. B. Saunders Company 1996: 285-93
11. Martindale, The Extra Pharmacopeia. Thirtieth Edition, The Pharmaceutical Press, London 1993. ISBN 085369 3005. ISSN 0263-5364

1-23. (canceled)

24. Composition
wherein the composition comprises about 1-17 g phosphate (1 mmol-180 mmol) and wherein phosphate, as the main active ingredient, corrects mammalian phosphate depletion.

25. Composition according to claim 24,
wherein the solution facilitates the emptying of the stomach and the transport of the active ingredient, energy, electrolytes and water from the intestine into the blood stream.

26. Composition according to either claim 24 or 25,
wherein the solution comprise 1-8 g phosphate per liter, preferably 4 g, more preferably 7 g per liter.

27. Composition according to claim 26,
wherein said composition further comprise preservative, stabilizer, such as sodium benzoate and potassium sorbate, buffer, flavoring agents and optionally sugar (except fructose).

28. Composition according to claim 26,
wherein the composition is a sports drink with the following composition;
1-17 g phosphate/l,
20-80 g monosaccharides (except fructose) and/or maltodextrines per liter (2-8%),
trisodiumphosphate (for sodium supply and pH adjustment) added to pH 3-5 (taste dependant),
0.01-5 g malic acid and/or other flavoring agents per liter,
0.01-025 g per liter of stabilizer E 211, sodium benzoate

29. Composition according to claim 26,
wherein the composition is a drink suitable for animal use with the following composition;
1-17 g phosphate/l,
trisodiumphosphate (for sodium supply and pH adjustment) added to pH 3.5-5 (taste dependant),
60 g melasse 60 per liter,
0.01-0.25 g/l of stabilizer E 211, sodium benzoate.

30. Composition according to claim 29,
wherein the animal is a horse.

31. Composition according to claim 24,
wherein it is in the form of a infusion solution which is isotonic.

32. Composition according to claim 31,
wherein said composition has the following composition;
1-17 g phosphate/l,
trisodiumphosphate up to isotonic solution and pH >4.

33. Composition according to claim 31,
wherein said composition has the following composition;
1-17 g phosphates/l,
1-1000 mg acetylsalicylic acid/l
trisodiumphosphate up to isotonic solution and pH >4.

34. Composition according to claim 31,
c wherein said composition in addition comprises acetylsalicylic acid.

35. Composition according to claim 26,
wherein the solution is made by dissolving a dry powder, a tablet or a concentrate in water, wherein the concentrations of phosphate, glucose and optionally melasse are in accordance with any of the claims 27-31.

36. Composition according to claim 35,
wherein it is a powder which is dissolved in a suitable liquid such as potable or distilled water immediate prior to the use of the composition.

37. Composition according to claim 35,
wherein it is in the form of a sports drink and with the provision that the composition does not comprises fructose.

38. A method of treating an animal suffering from a condition needing extra supply of phosphate, comprising administering to the animal an amount of the composition according to any one of claims 24-37 effective to alleviate the condition.

39. The method according to claim 38, wherein the animal is a human being.

40. The method according to claim 39, wherein the human being is an athlete.

41. The method according to either claim 38 or 39, wherein the subject suffers from the repercussion of the inlet of ethyl alcohol.

42. The method according to claim 39, wherein the composition is administered immediately prior to the inlet of ethyl alcohol, immediately after the inlet of ethyl alcohol, before bedtime, and the next morning, before nutrition consumption.

43. The method according to claim 38, wherein the composition is administered to a person suffering from or in risk of developing osteoporosis, and wherein the composition optionally is administered together with calcium.

44. A method of treating a patient being resuscitated or who has hypoxic injuries as a consequence of for instance cardiac arrest, infarction (for example myocardial infarction or stroke), shock and diabetic acidosis, or by the following, but not limited to, heart surgery, long lasting emesis, extended burns, large injections of insulin, poorly controlled diabetes, sepsis, malnutrition and other complications of alcoholism, traumas, adrenalin injections, parenteral hyperalimentation, alcohol withdrawal, severe metabolic or respiratory alkalosis, nasogastric suction, malabsorption, primary hyperthyroidism, acute severe asthma, acute respiratory failure and intravenous carbohydrate supply, comprising administering to the patient an amount of the composition according to any one of claims 24-37 effective to alleviate the condition.

45. The method according to 44, wherein the composition provides and/or enhances the formation of 2,3-DPG in an subject in need thereof.

46. The use according to claim 44, wherein the composition provides a sufficient supply of oxygen to the brain.

47. A pharmaceutical composition comprising the composition according to any one of claims 24-37, or a physiologically acceptable salt thereof and a pharmaceutically acceptable excipient or carrier.

48. Kit,
characterized in comprising the composition according to claim 26, liquid and further ingredients according to claim 29 in a manner which allows production of the solution immediately before use.

49. Kit,
characterized in comprising the composition according to claim 3, buffer, and optionally acetylsalicylic acid, in addition to adequate equipment for managing intravenous administration of the solution, in a manner which allows production of the solution immediately before use.
